(19) United States
(12) Patent Application Publication
(10) Pub. No.: US 2006/0214903 A1
(43) Pub. Date: Sep. 28, 2006

(54) Light-emitting device and display

(75) Inventor: Yoshitaka Kurosaka, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 10/546,327

(22) PCT Filed: Feb. 18, 2004
(86) PCT No.: PCT/JP04/01844

§ 371 Date: Aug. 19, 2005

(30) Foreign Application Priority Data
Feb. 21, 2003 (JP) 2003-044682

(51) Int. Cl. G09G 3/36

(52) U.S. Cl. 345/102

(57) ABSTRACT

Provided is a light-emitting element, and a direct-view type display, capable of expanding a color-reproduction range. A plain-surface light source (1) is capable of emitting light in an area corresponding to pixels by a variable light-emitting amount. A liquid crystal cell (2b) is formed in such a manner as to correspond to each pixel on the plain-surface light source (1). On the liquid crystal cell (2b), a birefringent plate (3) is provided. On the birefringent plate (3), a quantum dot layer (4) is formed. The quantum dot layer (4) is coated in such a manner as to have a first quantum dot layer (4a) (grain size A), and a second quantum dot layer (4b) (grain size B: A<B). During a 1-field period, it is possible to form a state that ultraviolet rays are guided only to the first quantum dot layer (4a) a state that the ultraviolet rays are guided to the both dot films (4a), (4b) at an arbitrary ratio, and a state that the ultraviolet rays are guided only to the second quantum dot layer (4b). This, in a case of light in red color, allows each of pixels for respective colors to create light in red color in which different red colors are mixed, for example.

### TECHNICAL FIELD

The present invention relates to a light-emitting element and a display.

### BACKGROUND ART

As a direct-view-type display-use panel, a liquid crystal display panel, a plasma display panel, and others have been known. In the liquid crystal display panel, applied voltage to pixel electrodes are controlled, thus an amount of light to be transmitted is controlled by each pixel. This allows amounts of light of R (red) pixels, G (green) pixels, and B (blue) pixels to differ, which results in a desired color being reproduced. In addition, in the plasma display panel, the number of applications of the voltage to the electrode (the number of sustain discharges between an X electrode and a Y electrode) so as to control a light-emitting amount, which renders different the light-emitting amounts of the R pixels, the G pixels, and the B pixels to differ. As a result, the desired color is reproduced.

It is noted that a colored light-emitting diode using quantum dots is known (Published Japanese translations of PCT international publication for patent applications No. 2002-510866).

In the above-described liquid crystal display panel, the plasma display panel, and others, an R light wavelength of the R pixels, a G light wavelength of the G pixels, and a B light wavelength of the B pixels are single wavelengths, respectively. As shown in FIG. 6, a color-reproduction range on a chromaticity diagram takes a triangular form, and it is not possible to reproduce the color beyond this range.

### SUMMARY OF THE INVENTION

In view of the above circumstance, it is an object of the present invention to provide a light-emitting element capable of changing a light-emitting color, and a display capable of expanding a color-reproduction range.

A light-emitting element according to the present invention (hereinafter, referred to as a first configuration) comprises a light-emitting portion in which a plurality of photoluminescent materials of which emitting-light colors differ from one another are arranged in zones, an emitting portion for emitting light for exciting the photoluminescent materials, and a switching means for selectively guiding to the photoluminescent materials of the light-emitting portion the light from the emitting portion.

In the above-described first configuration, it becomes possible to emit two kinds of light in red color, having different wavelengths each other, although the color as such is red, for example. In addition, it also becomes possible for one light-emitting element to emit completely different colors (red color and the green color, for example).

In the first configuration, the light emitting portion may be configured as follows. That is, the emitting portion may be formed of being provided with a light-emitting diode, and a means for controlling an amount of light that the light-emitting diode emits. Or, the emitting portion may be formed of being provided with an electroluminescent material and a means for controlling an amount of light that the electroluminescent material emits. Or, the emitting portion may be formed of being provided with a means for emitting light by exposing a fluorescent material to an electron beam, and a means for controlling an amount of light that the fluorescent material emits by controlling the electron beam (as such the emitting portion, CRT or a cold cathode panel are listed, for example). Or, the emitting portion may be formed of being provided with a means for emitting light obtained by a discharge, and a means for controlling an emitted light amount by controlling the discharge (as such the emitting portion, a plasma panel having or not having a fluorescent material is listed). Or, the emitting portion may be formed of being provided with backlight, and a liquid crystal panel for controlling an amount of transmitted light emitted from the backlight.

In the first configuration or in a configuration according to the first configuration, the switching means may be configured to generate a state that the light from the emitting portion is advanced straight, and a state that the light is not advanced straight. The switching means may be a means provided with at least one composition formed of a liquid crystal cell for performing a polarizing direction rotation control of predetermined polarized light from the emitting portion, a birefringent plate, and a controlling means for controlling energization to the liquid crystal cell. Or, the switching means may be a means provided with at least one composition formed of an acoustooptic effect element for selectively guiding to a plurality of areas by an acoustooptic effect the light from the emitting portion, and a controlling means for controlling energization to the acoustooptic effect element. The light-emitting portion may have a photoluminescent material that emits less efficiently, out of the plurality of the photoluminescent materials, at a position upon which the light advancing straight is incident. In addition, the light-emitting portion has a photoluminescent material that emits light in color of which visibility is lower, out of the plurality of the photoluminescent materials, at a position upon which the light advancing straight is incident.

In the first configuration or in a configuration according to the first configuration, a light-emitting element comprises a filter for cutting one portion of emitted light of the photoluminescent material, or all or one portion of excited light, on a light-emission side of the light-emitting portion. As the filter, a UV cut filter for cutting ultraviolet rays, which are excitation light, a cut-off filter for restricting a color range (improving a color-reproduction capability), or a band-pass filter are listed.

In addition, a light-emitting element of the present invention (hereinafter, referred to as a second configuration) comprises a light-emitting portion in which a plurality of photoluminescent materials of which emitting-light colors differ from one another are arranged in zones, an emitting portion for emitting an electron beam for exciting the photoluminescent materials, and a switching means for selectively guiding to the photoluminescent materials of the light-emitting portion the electron beam from the emitting portion.

With the above-described configuration, it is also possible to emit two kinds of light in red, having different wavelengths each other, although the color as such is red, for example. In addition, it is also possible for one light emitting element to emit completely different colors (red color and the green color, for example).

In the second configuration, the emitting portion may be formed of being provided with an electron gun or a cold cathode portion (a carbon nanotube, and others, for example) (as such the emitting portion, CRT or a filed mission panel, not having a fluorescent material, is listed, for example). In addition, in the second configuration or in a configuration according thereto, the switching means may be configured to generate a state that the electron beam from the emitting portion is advanced straight, and a state that the electron beam is not advanced straight. The switching means may be formed of a magnetic-field producing means for changing a course of the electron beam, and a controlling means for controlling energization to the magnetic-field producing means.

Furthermore, in the second configuration or in a configuration or in a configuration according thereto, a light-emitting element comprises a filter for cutting one portion of emitted light of the photoluminescent material, or all or one portion of excited light, on a light-emission side of the light-emitting portion.

A light-emitting element according to the present invention (hereinafter, referred to as a third configuration) comprises a first area having a photoluminescent material, a second area not having the photoluminescent material, an emitting portion for emitting visible light for exciting a photoluminescent material, and a switching means for selectively guiding to the first area and the second area the visible light from the emitting portion.

With the above-described configuration, it becomes possible to emit two kinds of light in red color, having different wavelengths each other, although the color as such is red, for example. In addition, it is also possible for one light emitting element to emit completely different colors (red color and the green color, for example).

In the third configuration, the emitting portion may be configured as follows. That is, the emitting portion may be configured to be provided with a light-emitting diode for emitting the visible light, and a means for controlling an amount of light that the light-emitting diode emits. Or, the emitting portion may be configured to be provided with an electroluminescent material for emitting the visible light, and a means for controlling an amount of light that the electroluminescent material emits. Or, the emitting portion may be configured to be provided with a means for emitting light by exposing a fluorescent material to an electron beam, and a means for controlling an amount of light that the fluorescent material emits by controlling the electron beam (as such the emitting portion, the CRT or the field emission panel is listed, for example). Or, the emitting portion may be configured to be provided with a means for emitting the visible light by exposing a fluorescent material to light obtained by a discharge, and a means for controlling an amount of light that the visible light emits by controlling the discharge (as such the emitting portion, the plasma panel is listed, for example). Or, the emitting portion may be configured to be provided with backlight for emitting the visible light, and a liquid crystal panel for controlling an amount of transmitted light emitted from the backlight.

In the third configuration or in a configuration according thereto, the switching means may be configured to generate a state that the light from the emitting portion is advanced straight, and a state that the light is not advanced straight. The switching means may be a means provided with at least one composition formed of a liquid crystal cell for performing a polarizing-direction rotation control of predetermined polarized light from the emitting portion, a birefringent plate, and a controlling means for controlling energization to the liquid crystal cell. Or, the switching means may be provided with at least one composition formed of an acoustooptic effect element for selectively guiding to a plurality of areas by an acoustooptic effect the light from the emitting portion, and a controlling means for controlling energization to the acoustooptic effect element.

In the third configuration or in a configuration according thereto, a light-emitting element may be configured to comprise a filter for cutting one portion of light that the photoluminescent material emits, or one portion of the visible light or undesired ultraviolet rays from the emitting portion, on a light-exit side of the area. In addition, as the filter, a cut-off filter or a band-pass filter may be used for restricting a color range (improving a color-reproduction capability).

In the above configurations, the photoluminescent material may be a quantum dot of which light-emitting color differs depending by each size.

In addition, a display according to the present invention is formed of having in plural light-emitting elements according to any one of the light-emitting elements described above as pixels. In the above-described display, a full-color video display may be performed by appropriately emitting light in red color, light in green color, and light in blue color.

In a case of utilizing the first configuration, the emitting portion is configured to receive the light in blue color, which is excitation light, and to emit light by switching between the light in red color and the light in green color, for example. A series of these emitting portions are formed with gaps therebetween, which are provided on a liquid crystal panel having backlight emitting the light in blue color. This formation allows the light in red color and the light in green color to be emitted from the light-emitting portion, and the light in blue color to be emitted from the gaps. If both the light-emitting portions and the gaps are regarded as a pixel, the display according to the present invention is a display capable of performing a full-color display by two pixels.

Furthermore, in a configuration capable of performing the above-described full-color video display, it may be configured such that light in certain color, which is at least one of light in red color, light in green color, and light in blue color, of which wavelengths differ each other, is emitted. With the above-described configuration, the pixel may successively between two kinds of light in red color, of which wavelengths differ, although the color as such is red, for example, thus possible to transform the color-reproduction range on a chromaticity diagram into a polygon, which has four or more vertices. This makes it possible to reproduce the colors beyond a conventional triangular-shaped color-reproduction range.

In addition, in a configuration capable of performing the above-described full-color video display, a display may be configured to appropriately emit light in another color (light in cyan color, light in yellow color, and light in magenta color, for example) other than three colors, that is, red, green, and blue. In such the configuration, too, it is possible to expand the color-reproduction range.

### BRIEF DESCRIPTION OF THE DRAWINGS

FIG. 1 is a cross-sectional diagram showing structure of a light emitting element (pixel in a direct-view type display) of an embodiment of the present invention;

FIG. 2(a) and FIG. 2(b) are operation descriptive diagrams of the light emitting element (pixel in a direct-view type display) in FIG. 1;

FIG. 3 is a descriptive diagram showing a color-reproduction range of the direct-view type display in FIG. 1;

FIG. 4 is a descriptive diagram showing an acoustooptic effect element;

FIG. 5 is a descriptive diagram showing an example of a plane light source; and

FIG. 6 is a descriptive diagram showing a color-reproduction range of a conventional display.

### BEST MODE FOR PRACTICING THE INVENTION

### Embodiment 1

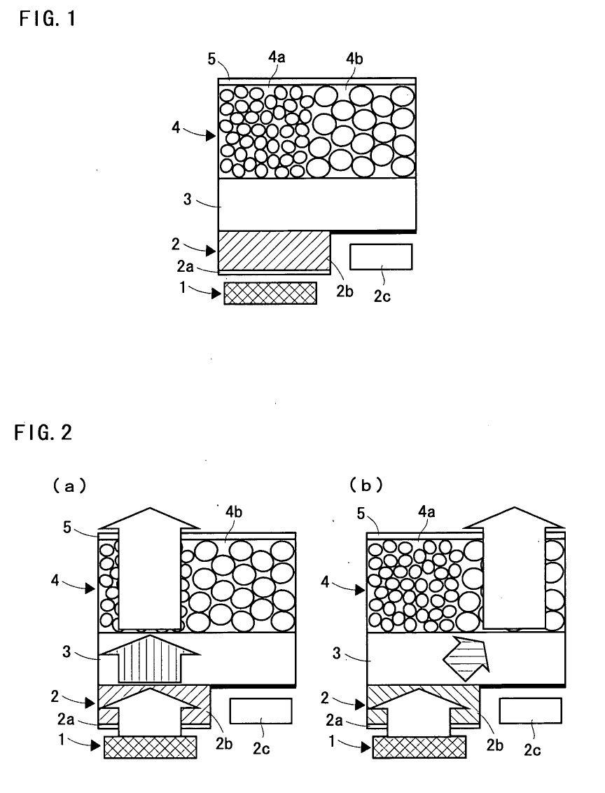

Hereinafter, a light-emitting element and a direct view-type display according to an embodiment of the present invention will be described based on FIG. 1 to FIG. 5.

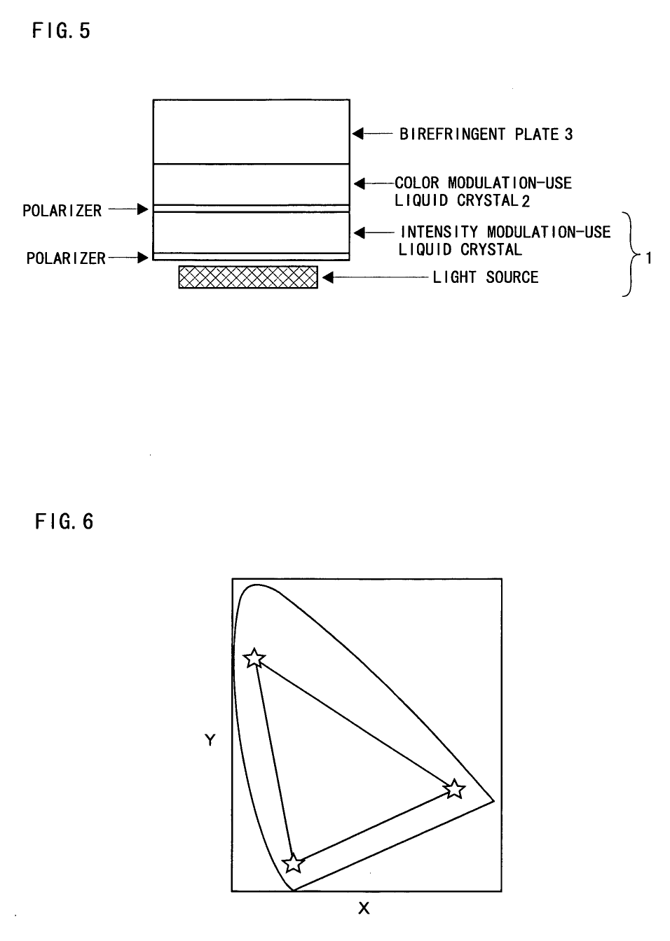

FIG. 1 is a sectional view showing structure of a pixel (structure of a light-emitting element) in a direct view-type display of this embodiment. A plane light source (emitting portion) 1 is a light source for emitting ultraviolet rays, which is excitation light, and is configured to be capable of changing an amount of light guided to each pixel. Such the plane light source 1 may be configured to have backlight formed of a lamp emitting the ultraviolet rays and a light guide plate, and a transmissive liquid crystal panel provided on a light-emission side of this backlight. That is, by changing an applied voltage value to a pixel electrode in the liquid crystal panel, it becomes possible to render variable the amount of light guided to the light-emitting portion within each pixel variable (see FIG. 5).

In addition, as the plane light source 1, it is possible to use a plasma display panel not having a fluorescent material. As well known, a plasma display panel is a display panel for selecting a discharge pixel (light-emitting pixel) and for controlling the number of discharges (light-emitting amount), by controlling an X electrode, a Y electrode, and an address electrode. More specifically, X-sus (sustain) data is input to the X electrode, Y-sus (sustain) data is input to the Y electrode, and address data is input to the address electrode. The address data is data for controlling light-emitting/non-light-emitting regarding the each one of the pixels of plasma panel display. Light-emitting luminance of the pixels is controlled by the number of discharges based on the X-sus data and the Y-sus data. An amount of light that pixels in respective colors emit in such the plane light source 1 is controlled by a luminance signal in a video signal.

On the plane light source 1, a polarization control-use liquid crystal panel 2 is provided. On a light-incidence surface of the polarization control-use liquid crystal panel 2, a polarizer 2a for transmitting only a specific polarizing component is provided, out of ultraviolet light emitted from the plane light source 1, so as to transform the polarizing direction into one direction. In addition, in this polarization control-use liquid crystal panel 2, a liquid crystal cell 2b is formed in such a manner as to correspond to light-emitting areas, which is each pixel, on the plane light source 1. This liquid crystal cell 2b is driven by a TFT (thin-film transistor) 2c. The liquid crystal cell 2b is capable of rotating a polarizing direction of the emitted light according to voltage to be applied. A driver for driving the TFT 2c changes the applied voltage to the liquid crystal cell and successively rotates the polarizing direction so as to successively change a ratio of light between first polarized light and second polarized light.

A birefringent plate 3 is provided on the polarization control-use liquid crystal panel 2. As shown in FIG. 2(a), (b), the birefringent plate 3 allows the first polarized light to advance straight as ordinary light, and on the other hand, the second polarized light to be guided diagonally to the upper right in FIG. 2(b) as extraordinary light.

A quantum dot layer (light-emitting portion) 4 is formed on the birefringent plate 3. A quantum dot is formed of a micro semiconductor, has a characteristic of receiving excitation light (ultraviolet rays) from the light source and emitting light (visible light) of which wavelength is longer than the excitation light, and has an emitting-light color (emitted-light wavelength) different depending on its size (grain size). The quantum dot layer 4 is coated in such a manner as to have a first quantum dot layer 4a (grain size A), and a second quantum dot layer 4b (grain size B: A<B) on light-emitting areas, which is each pixel, of the plane light source 1. In addition, in an area for receiving the ultraviolet rays that passes and advances through the birefringent plate 3, the first quantum dot layer 4a is positioned, and in an area for receiving the ultraviolet rays that passes through the birefringent plate 3 in a refracting manner, the second quantum dot layer 4b is positioned. These quantum dot layers are formed through a coating process by an ink-jet coating, for example. Furthermore, on the quantum dot layer 4, an ultraviolet rays cut-filter 5 is provided.

In this embodiment, as the quantum dot layer 4, an R (red)-use quantum dot layer, a G (green)-use quantum dot layer, and a B (blue)-use quantum dot layer are formed, and the quantum dot layers for the respective colors are arranged and formed in a stripe arrangement or a delta arrangement, and others. Furthermore, in the R-use quantum dot layer 4, sizes of the quantum dot of the first quantum dot layer 4a and the quantum dot of the second quantum dot layer 4b are adjusted so that two kinds of light in red color, of which colors are red but of which wavelengths differ each other, are emitted, although the color as such is red, in the G-use quantum dot layer 4, sizes of the quantum dot of the first quantum dot layer 4a and the quantum dot of the second quantum dot layer 4b are adjusted so that two kinds of light in green color, of which colors are green but of which wavelengths differ each other, are emitted, although the color as such is green, and in the B-use quantum dot layer 4, sizes of the quantum dot of the first quantum dot layer 4a and the quantum dot of the second quantum dot layer 4b are adjusted so that two kinds of the light in blue color, of which colors are blue but of which wavelengths differ each other, are emitted, although the color as such is blue.

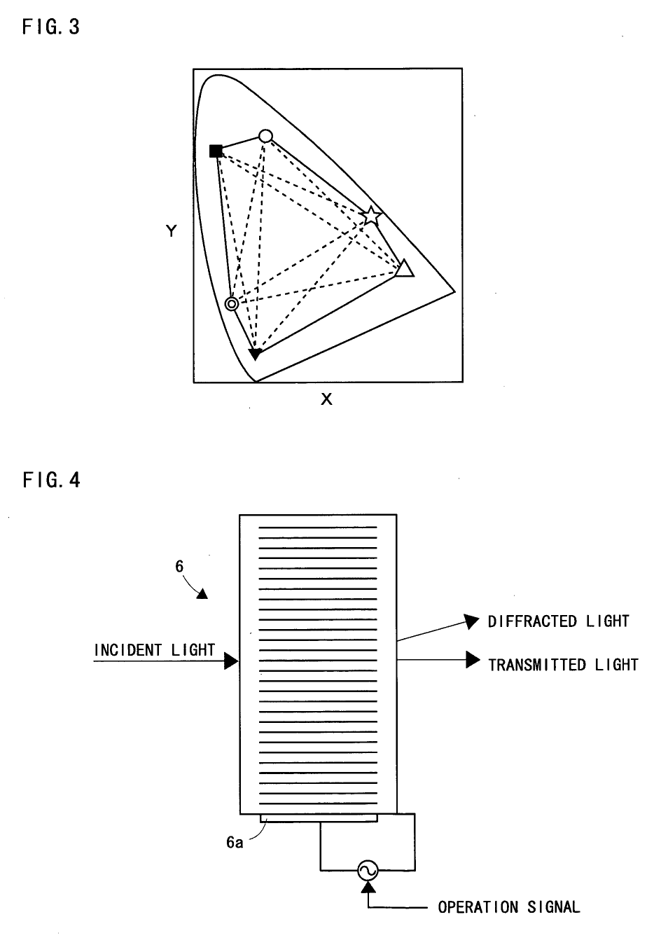

Therefore, in a 1-field period, it is possible to generate a state that the ultraviolet rays are guided only to the first quantum dot layer 4a, a state that the ultraviolet rays are guided at an arbitrary ratio to both the first quantum dot layer 4a and the second quantum dot layer 4b, and a state that the ultraviolet rays are guided only to the second quantum dot layer 4b, for example. Therefore, the pixels for the respective colors, regarding the red color, for example, are capable of creating light in red color in which light in various red colors of which wavelengths differ are mixed, although the color as such is red. As a result, on a chromaticity diagram, the red color does not exist as a single point, but the red color is capable of existing as arbitrary points on a line, which connects Δ (triangle) and ⋆ (star) as shown in FIG. 3. Furthermore, this means that regarding the other colors, too, it becomes possible to exist not as the single point but the arbitrary points on the line on the chromaticity diagram. In certain timing, a color-reproduction range is in a triangle shape (see dotted lines in FIG. 3) formed by connecting certain points of the respective colors, and in another timing, the color-reproduction range is in a triangle shape different from the above triangle (see dotted lines in FIG. 3) formed by connecting other arbitrary points of respective colors. This results in the color-reproduction range dramatically expanding, compared to a conventional case.

In the above-described embodiment, although the control for guiding the light to the first quantum dot layer 4a or the second quantum dot layer 4b is performed by the polarization control-use liquid crystal panel 2 and the birefringent plate 3, this control may also be performed by using an acoustooptic effect element 6 shown in FIG. 4. The acoustooptic effect element 6 has an oscillator 6a connected to a high-frequency power, and is capable of controlling turning on/off diffracted light by turning on/off the high-frequency power. That is, as a result of the ultraviolet rays from the plane light source 1 being configured to be guided to the first quantum dot layer 4a when the diffracted light is turned off, and the ultraviolet rays from the plane-surface light source 1I being configured to be guided to the second quantum dot layer 4b when the diffracted light is turned on, the light-emitting element becomes capable of controlling an amount of light that the first quantum dot layer 4a emits and an amount of light that the second quantum dot layer 4b emits.

As the light source (emitting portion), it is possible to use a light source provided with a light-emitting diode, and a supplied-power control portion for controlling an amount of light that the light-emitting diode emits. Or, as the light source (emitting portion), it is possible to use a light source provided with an electroluminescent (EL) material, and a supplied-power control portion for controlling an amount of light that the electroluminescent material emits. Either an organic-type electroluminescent material or an inorganic-type electroluminescent material may be used. Or, as the light source (emitting portion), CRT and a field emission panel are used, for example. It is noted that as a fluorescent material of the CRT or the field emission panel, a fluorescent material for emitting the ultraviolet rays in receiving an electron beam, and others, are used. Besides the ultraviolet rays, any light for exciting the photoluminescent material may be used.

Incidentally, there is a case that light-emitting efficiency of the first quantum dot layer 4a and the second quantum dot layer 4b is not the same. In this case, if the light-emitting efficiency of the first quantum dot layer 4a is lower than that of the second quantum dot layer 4b, the first quantum dot layer 4a is preferably placed at a position upon which the advancing light (ordinary light) is incident, and the second quantum dot layer 4b is preferably placed at a position upon which the extraordinary light is incident. Since transmittance of the ordinary light is higher than that of the extraordinary light, by guiding the ordinary light to the dot film having the lower light-emitting efficiency, it becomes easy to render the luminance uniform.

Furthermore, visibility of the light that the first quantum dot layer 4a emits and visibility of the light that the second quantum dot layer 4b emits are not the same. The light in green color is higher in visibility than the light in red color and the light in blue color. Thus, if the visibility of the light that the first quantum dot layer 4a emits is lower than that of the light that the second quantum dot layer 4b emits, the first quantum dot layer 4a is preferably placed at a position upon which the advancing light (ordinary light) is incident, and the second quantum dot layer 4b is preferably placed at a position upon which the extraordinary light is incident. This placement allows a difference in visibility to be compensated by a difference in light amount.

In addition, in the above-described example, an ultraviolet rays cut filter 5 is provided on the quantum dot layer 4 so as to cut leaked ultraviolet rays (excitation light). However, in addition to this configuration, a cut-off filter and a band-pass filter may be provided for restricting a color range of the light-emitting color (improving the color-reproduction capability).

Furthermore, although there is shown a case that the color-reproduction range is in a hexagon shape (see FIG. 3), this range may take another shape. For example, a first light-emitting element in which the first quantum dot layer 4a emits the light in red color (R) and the second quantum dot layer 4b emits a first light in green color (G1), and a second light-emitting element in which the first quantum dot layer 4a emits the light in blue color (B) and the second quantum dot layer 4b emits a second light in green color (G2) are combined. This combination enables to allow the light in green color to exist not as a single point but as arbitrary points on the line, which connect two points, on a chromaticity diagram, and thus, the color-reproduction range is in a square shape. Needless to say, it is also possible to be configured such that the color-reproduction range takes another polygonal shape. It is noted that from a viewpoint of the above-described visibility, the light-emitting element may preferably be configured to guide the ordinary light to the quantum dot layer for emitting the light in red color or the light in blue color.

In addition, although in the above-described example, there is shown the quantum dot layers having different grain sizes as a plurality of the photoluminescent materials of which light-emitting colors differ from one another, there may be another quantum dot layer as a photoluminescent material. Furthermore, although there is shown the photoluminescent material for emitting the visible light in receiving an exposure of the ultraviolet rays, a photoluminescent material for emitting light in receiving the electron beam may also be used. In this case, as the emitting portion for emitting the electron beam, the field emission display or the CRT (cathode-ray tube) may be used. In addition, in a case of using the field emission display, micro coils are formed for every pixel, and a direction of the electron beam is changed by turning on/off the energization to the micro coils.

In addition, although in the above-described example, the two photoluminescent materials of which light-emitting colors differ from each other are combined so as to form one pixel (light-emitting element), a first area having the photoluminescent material and a second area not having the photoluminescent material may be combined so as to form one pixel (light-emitting element). In this case, as the light source (emitting portion), a light source emitting the visible light is used. If light of the light source is the light in blue color, and the photoluminescent material in the first area is excited by the light in blue color, and as a result, emits the light in green color, it becomes possible to create the light in blue color and the light in green color. Furthermore, if a light-emitting element, in which the photoluminescent material in the first area is excited by the light in blue color, and as a result, the light in red color is emitted, is combined with the above light-emitting element, it becomes possible to emit light in three primary colors. In addition, for example, if a light-emitting element emitting light in red color of which color is slightly different from the above-described light in red color is combined with the above light-emitting element, it becomes possible to expand the color-reproduction range on the chromaticity diagram.

Furthermore, in such the configuration, as the light source (visible light emitting portion), a light source provided with a light-emitting diode emitting the visible light, and a supplied-power control portion for controlling an amount of light that the light-emitting diode emits may be used. Or, as the light source, a light source provided with an electroluminescent material for emitting the visible light, and a supplied-power control portion for controlling an amount of light that the electroluminescent material emits may be used. In addition, as the light source, it is possible to use the CRT and the field emission panel, for example. It is noted that as a fluorescent material of the CRT and the field emission panel, a fluorescent material for emitting the visible light (the light in blue color, and others) in receiving the electron beam is used. Or, as the light source, it is possible to use a plasma panel having the fluorescent material. It is noted that as the fluorescent material, a fluorescent material for emitting the visible light (the light in blue color, and etc.) in receiving the ultraviolet rays is used. In addition, as the light source, it is possible to use a liquid crystal panel having backlight for emitting the visible light.

Furthermore, in a case that the ultraviolet rays are leaked, a UV cut filter may be provided on a light-emission side of the light-emitting portion. In addition, in order to restrict the color range of the light-emitting color (in order to improve the color reproduction), a cut-off filter and a band-pass filter may be provided.

Furthermore, in the configurations described above (except for an electron beam exciting type), by providing an optical path switching means formed of the polarization control-use liquid crystal panel 2 and the birefringent plate 3, or an optical path switching means formed of the acoustooptic effect element 6 on numerous layers, it becomes possible to selectively guide the light into the three or more areas, and it may be possible to arrange in these areas a plurality of photoluminescent materials of which light-emitting colors differ.

As described above, the light-emitting element of the present invention is capable of emitting two kinds of light in red color, having different wavelengths, although the color as such is red, for example. In addition, it becomes also possible for one light-emitting element to emit completely different colors (red color and the green color, for example). Furthermore, in the display of the present invention, a colors-use pixel may successively change between two kinds of light in red color, having different wavelengths differ, although the color as such is red, for example, so that it is possible to expand the color-reproduction range. In addition, in a case of a full-color display, in addition to the light in red color, the light in green color, and the light in blue color, it may be possible to appropriately emit the light of which colors are other than these colors (light in cyan color, light in yellow color, and light in magenta color, for example), and in such the configuration, it is also possible to expand the color-reproduction range.

1. A light-emitting element, comprising:
a light-emitting portion in which two photoluminescent materials of which light-emitting colors differ from one another are arranged in zones;
an emitting portion for emitting light for exciting the photoluminescent materials; and
a switching means capable of forming a state that the light from the emitting portion is guided to all the two photoluminescent materials of the light-emitting portion, or a state that the light from the emitting portion is guided to one of the two photoluminescent materials of the light-emitting portion, during a predetermined period (1-field period, for example).

2. A light-emitting element according to claim 1, wherein the emitting portion is formed of being provided with a light-emitting diode and a means for controlling an amount of light that the light-emitting diode emits.

3. A light-emitting element according to claim 1, wherein the emitting portion is formed of being provided with an electroluminescent material and a means for controlling an amount of light that the electroluminescent material emits.

4. A light-emitting element according to claim 1, wherein the emitting portion is formed of being provided with a means for emitting light by exposing a fluorescent material to an electron beam, and a means for controlling an amount of light that the fluorescent material emits by controlling the electron beam.

5. A light-emitting element according to claim 1, wherein the emitting portion is formed of being provided with a means for emitting light obtained by a discharge, and a means for controlling an emitted-light amount by controlling the discharge.

6. A light-emitting element according to claim 1, wherein the emitting portion is formed of being provided with backlight, and a liquid crystal panel for controlling an amount of transmitted light emitted from that the backlight.

7. A light-emitting element according to claim 1, wherein the switching means is configured to generate a state that the light from the emitting portion is advanced straight, and a state that the light is not advanced straight.

8. A light-emitting element according to claim 7, wherein the switching means is provided with at least one composition formed of a liquid crystal cell for performing a polarizing-direction rotation control of predetermined polarized light from the emitting portion, a birefringent plate, and a controlling means for controlling energization to the liquid crystal cell.

9. A light-emitting element according to claim 7, wherein the switching means is provided with at least one composition formed of an acoustooptic effect element for selectively guiding to a plurality of areas by an acoustooptic effect the light from the emitting portion, and a controlling means for controlling energization to the acoustooptic effect element.

10. A light-emitting element according to claim 7, wherein the light-emitting portion has a photoluminescent material that emits light less efficiently, out of the plurality of photoluminescent materials, at a position upon which the light advancing straight is incident.

11. A light-emitting element according to claim 7, wherein the light-emitting portion has a photoluminescent material that emits light in color of which visibility is lower, out of the plurality of photoluminescent materials, at a position upon which the light advancing straight is incident.

12. A light-emitting element according to claim 1, comprising a filter for cutting one portion of light that the photoluminescent material emits, or all or one portion of light for exciting the photoluminescent material, on a light-emission side of the light-emitting portion.

13. A light-emitting element, comprising:
a light-emitting portion in which a plurality of photoluminescent materials of which light-emitting colors differ from one another are arranged in zones;
an emitting portion for emitting an electron beam for exciting the photoluminescent material; and
a switching means for selectively guiding to the photoluminescent materials of the light-emitting portion the electron beam from the emitting portion.

14. A light-emitting element according to claim 13, wherein the emitting portion is formed of being provided with an electron gun or a cold cathode portion.

15. A light-emitting element according to claim 13 or 14, wherein the switching means is configured to generate a state that the electron beam from the emitting portion is advanced straight, and a state that the electron beam is not advanced straight.

16. A light-emitting element according to claim 15, wherein the switching means is formed of a magnetic-field producing means for changing a course of the electron beam, and a controlling means for controlling energization to the magnetic-field producing means.

17. A light-emitting element according to claim 13 or 14, comprising a filter for cutting one portion of light that the photoluminescent material emits, on a light-emission side of the light-emitting portion.

18. A light-emitting element, comprising:
a first area having photoluminescent material;
a second area not having the photoluminescent material;
an emitting portion for emitting visible light for exciting the photoluminescent material; and
a switching means for selectively guiding to the first area or the second area the visible light from the emitting portion.

19. A light-emitting element according to claim 18, wherein the emitting portion is formed of being provided with a light-emitting diode for emitting the visible light, and a means for controlling an amount of light that the light-emitting diode emits.

20. A light-emitting element according to claim 18, wherein the emitting portion is formed of being provided with an electroluminescent material for emitting the visible light, and a means for controlling an amount of light that the electroluminescent material emits.

21. A light-emitting element according to claim 18, wherein the emitting portion is formed of being provided with a means for emitting the visible light by exposing a fluorescent material to an electron beam, and a means for controlling an amount of light that the fluorescent material emits by controlling the electron beam.

22. A light-emitting element according to claim 18, wherein the emitting portion is formed of being provided with a means for emitting the visible light by exposing a fluorescent material to light obtained by a discharge, and a means for controlling an amount of light that the visible light emits by controlling by the discharge.

23. A light-emitting element according to claim 18, wherein the emitting portion is formed of being provided with backlight for emitting the visible light, and a liquid crystal panel for controlling an amount of transmitted light emitted from the backlight.

24. A light-emitting element according to claim 18, wherein the switching means is configured to generate a state that the light from the emitting portion is advanced straight, and a state that the light is not advanced straight.

25. A light-emitting element according to claim 24, wherein the switching means is provided with at least one composition formed of a liquid crystal cell for performing a polarizing-direction rotation control of predetermined polarized light from the emitting portion, a birefringent plate, and a controlling means for controlling energization to the liquid crystal cell.

26. A light-emitting element according to claim 24, wherein the switching means is provided with at least one composition formed of an acoustooptic effect element for selectively guiding to a plurality of areas by an acoustooptic effect the light from the emitting portion, and a controlling means for controlling energization to the acoustooptic effect element.

27. A light-emitting element according to claim 18, comprising a filter for cutting one portion of light that the photoluminescent material emits, or one portion of the visible light or undesired ultraviolet rays from the emitting portion, on a light-exit side of the area.

28. A light-emitting element according to claim 1 or 18, wherein the photoluminescent material is a quantum dot of which light-emitting color differs by each size.

29. A display, formed of having in plural light-emitting elements according to claim 1 or 18 as pixels.

30. A display according to claim 29, configured to be capable of performing a full-color display by appropriately emitting light in red color, light in green color, and light in blue color.

31. A display according to claim 30, configured such that light in certain color, which is at least one of light in red color, light in green color, and light in blue color, of which wavelengths differ from one another, is emitted.

32. A display according to claim 30, configured to appropriately emit light in colors, of which colors contain other than red, green, and blue
